(19) United States
(12) Patent Application Publication
(10) Pub. No.: US 2025/0091329 A1
(43) Pub. Date: Mar. 20, 2025

(54) LAMINATES AND INTERLAYERS THEREOF AND METHODS FOR THE SAME

(71) Applicant: DelStar Technologies, Inc, Alpharetta, GA (US)

(72) Inventor: Nandan Ukidwe, Suffield, CT (US)

(21) Appl. No.: 18/829,751

(22) Filed: Sep. 10, 2024

Related U.S. Application Data
(60) Provisional application No. 63/583,626, filed on Sep. 19, 2023.

(51) Int. Cl. B32B 17/10

(52) U.S. Cl. CPC B32B 17/1077; B32B 17/10036; B32B 17/10788; B32B 2274/00; B32B 2307/414; B32B 2307/422; B32B 2307/542

(57) ABSTRACT

Laminates and interlayers thereof are provided. The laminates may include a first optically transparent sheet, a second optically transparent sheet, and an interlayer. The interlayer may be interposed between the first and second optically transparent sheets, and may couple the first and second optically transparent sheets with one another. The interlayer may include one or more structural support layers and one or more polymeric layers. A first polymeric layer of the one or more polymeric layers may include a luminophore. The interlayer may be substantially free of plasticizers.

### CROSS-REFERENCE TO RELATED APPLICATIONS

This application claims priority to U.S. Provisional Patent Application No. 63/583,626 filed on Sep. 19, 2023, the contents of which are incorporated herein by reference to the extent consistent with the present disclosure.

### TECHNICAL FIELD

This description generally relates to laminates and interlayers thereof including luminophores and excluding plasticizers.

### BACKGROUND

Laminated Glazing Units (LGUs) are laminated assemblies including transparent rigid plies or sheets (e.g., glass, polycarbonate, etc.) coupled with one another via an interlayer disposed therebetween. The interlayer may be or include a thermoplastic material such as polyvinyl formal, polyvinyl butyral, polyvinyl iso-butyral, silicone, or ethylene vinyl acetate (EVA). In conventional applications, such as automotive or architectural glass-glass laminations, the interlayer often utilizes plasticized thermoplastic materials, such as plasticized polyvinyl butyral. Plasticized thermoplastic materials offer favorable properties including sufficient glass adhesion, exceptional optical clarity, robust durability, and resistance to high impact. While thermoplastic materials have provided various benefits, recent trends have attempted to reduce the use of plasticizers for various reasons.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a laminate, including: a first optically transparent sheet, a second optically transparent sheet, and an interlayer interposed between the first optically transparent sheet and the second optically transparent sheet. The interlayer may couple the first and second optically transparent sheets with one another. The interlayer may include one or more structural support layers, and one or more polymeric layers. A first polymeric layer of the one or more polymeric layers may include a luminophore. In at least one aspect, the laminate may be free or substantially free of plasticizers.

In one aspect, the first polymeric layer may include a thermoplastic polyurethane, and the luminophore may be disposed in the thermoplastic urethane.

In one aspect, a second polymeric layer of the one or more polymeric layers may include a thermoplastic polyurethane. In one aspect, the second polymeric layer may include a luminophore. In one aspect, the second polymeric layer may not include a luminophore.

In one aspect, the one or more structural support layers may be interposed between the first polymeric layer and the second polymeric layer.

In one aspect, the one or more structural support layers may include an ionomeric polymer.

In one aspect, the one or more structural support layers may include a polycarbonate, a polymethyl methacrylate, a polyethylene terephthalate, a polyesterimide, or a combination thereof.

In one aspect, the one or more structural support layers may include a first structural support layer and a second structural support layer.

In one aspect, at least one of the first structural support layer and the second structural support layer may include a thermoplastic polyurethane, a cross-linked ethylene-vinyl acetate, or a combination thereof.

In one aspect, each of the first structural support layer and the second structural support layer may include the thermoplastic polyurethane.

In one aspect, each of the first structural support layer and the second structural support layer may include the cross-linked ethylene-vinyl acetate.

In one aspect, the first polymeric layer may be interposed between the first structural support layer and the second structural support layer.

In one aspect, at least the first polymeric layer of the one or more polymeric layers may include an adhesion promoter.

In one aspect, the luminophore may include one or more of an organic phosphorescent molecule, a quantum dot, an organic dye, a fluorophore, or a combination thereof.

In one aspect, the luminophore may include the organic phosphorescent molecule. In one aspect, the luminophore may include a quantum dot.

In one aspect, the quantum dot may include a core/shell structure selected from one or more of CdSe/CdS, CdSe/ZnSe, CdSe/ZnS, CdSe/ZnTe, CdSe/CdTe, CdTe/CdSe, CdTe/CdS, CdTe/ZnSe, CdTe/ZnS, CdTe/ZnTe, CdS/ZnSe, CdS/ZnS, CdS/CdTe, CdS/CdSe, PbSe/PbS, PbS/PbSe, PbTe/PbS, PbS/PbTe, PbTe/PbSe, PbSe/PbTe, PbSe/CdSe, CdSe/PbTe, PbS/CdS, CdS/PbS, PbTe/CdTe, CdTe/PbTe, InAs/CdS, InSb/CdS, InP/CdS, InAs/CdSe, InSb/CdSe, InP/CdSe, InAs/ZnSe, InP/ZnSe, InSb/ZnSe, InAs/ZnS, InP/ZnS, InSb/ZnS, Ge/Si, Si/Ge, Sn/Si, Si/Sn, Ge/Sn, Sn/Ge, or a combination thereof.

In one aspect, the laminate may further include one or more adhesive promoters disposed in the first polymeric layer, the second polymeric layer, or a combination thereof.

In one aspect, the laminate may have a haze of less than or equal to about 2%.

In one aspect, the laminate may have a light transmission of greater than or equal to about 30%.

In one aspect, the laminate may have a quantum yield of greater than or equal to about 50%.

In one aspect, the laminate may have an indentation resistance of greater than or equal to about 18 feet, or greater than or equal to about 5.5 meters, as measured according to ASTM-D2394.

In one aspect, the laminate may have a pummel adhesion of greater than or equal to about 4, as measured according to ASTM C1908-21.

In one aspect, the laminate may have a shear storage modulus of greater than or equal to about 1 MPa, as measured at about 50° C.

The foregoing and/or other aspects and utilities described herein may be achieved by providing a laminate including: a first optically transparent sheet; a second optically transparent sheet; and an interlayer interposed between the first optically transparent sheet and the second optically transparent sheet. the interlayer may be substantially free of plasticizers. The interlayer may include: a first polymeric layer that may include a luminophore and a thermoplastic polyurethane; a second polymeric layer that may include a thermoplastic urethane; and a structural support layer interposed between the first polymeric layer and the second polymeric layer.

In one aspect, the second polymeric layer may include a luminophore.

In one aspect, the second polymeric layer may not include a luminophore.

In one aspect, the one or more structural support layers may include an ionomeric polymer.

In one aspect, the one or more structural support layers may include a polycarbonate, a polymethyl methacrylate, a polyethylene terephthalate, a polyesterimide, or a combination thereof.

The foregoing and/or other aspects and utilities described herein may be achieved by providing a laminate including: a first optically transparent sheet; a second optically transparent sheet; and an interlayer interposed between the first optically transparent sheet and the second optically transparent sheet. The interlayer may be substantially free of plasticizers. The interlayer may include: a first structural support layer that may include a thermoplastic polyurethane or a cross-linked ethylene-vinyl acetate; a second structural support layer that may include a thermoplastic polyurethane or a cross-linked ethylene-vinyl acetate; and a polymeric layer interposed between the first structural support layer and the second structural support layer. The polymer layer may include a luminophore.

In one aspect, at least one of the first structural support layer and the second structural support layer may include a thermoplastic polyurethane, a cross-linked ethylene-vinyl acetate, or a combination thereof.

In one aspect, each of the first structural support layer and the second structural support layer may include the thermoplastic polyurethane.

In one aspect, each of the first structural support layer and the second structural support layer may include the cross-linked ethylene-vinyl acetate.

The foregoing and/or other aspects and utilities described herein may be achieved by providing a window including any one or more of the laminates discussed and described herein.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 is a schematic cross-sectional view of an exemplary laminate, according to one or more implementations discussed herein.

FIG. 2 is a schematic cross-sectional view of another exemplary laminate, according to one or more implementations discussed herein.

FIG. 3 is a partial, cross-sectional view of an exemplary multilayer laminate assembly, according to one or more implementations discussed herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), +0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically disclosed.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

Laminates and/or interlayers thereof having improved or comparable optical and/or mechanical properties as compared to conventional laminates and interlayers are discussed herein. For example, the laminates and/or interlayers thereof may have improved or comparable properties with respect to one or more of impact resistance, load bearing capacity, luminescence, solar control functionality, spall protection, acoustic damping, or the like, or any combination thereof. As further described herein, the laminates and/or the interlayers thereof may be free or substantially free of plasticizers. The laminate and the interlayers thereof may be utilized as a window, a glass panel, a glazing, and/or an energy harvesting structural laminated glazing unit (LGU), in various applications and/or industries including, but not limited to, architectural, vehicle, or transportation application and industries. Illustrative applications may be or include, but are not limited to, an automobile or a locomotive windshield, sidelam, rear window or sunroof, an airplane window or canopy, windows in a residential or commercial building, balustrades, balconies and stairs, a decorative panel or covering for walls, columns, an elevator, other architectural applications, a cover for signs, a display, an appliance, an electronic device, furniture, or the like. As used herein, the term “glazing” or “laminate” may refer to a transparent, semi-transparent, translucent, or opaque window, panel, wall, or other structure, or a portion/part thereof having at least one optically transparent sheet (e.g., rigid outer ply, glass sheet, polymeric sheet, etc.) laminated or otherwise coupled with another optically transparent sheet via an interlayer. For example, the laminate may be a clear or tinted laminated glass.

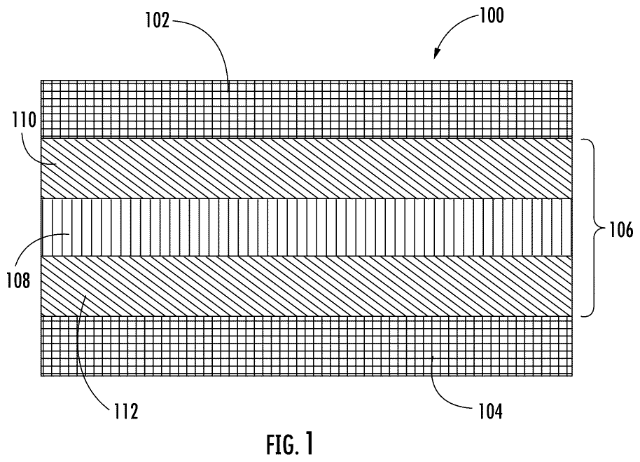

FIG. 1 is a schematic cross-sectional view of an exemplary laminate 100, according to one or more implementations. The laminate 100 may include one or more optically transparent sheets (two are shown 102, 104), an interlayer 106, or a combination thereof. For example, the laminate 100 may include a first optically transparent sheet 102, a second optically transparent sheet 104, and an interlayer 106 interposed between the first optically transparent sheet 102 and the second optically transparent sheet 104. The interlayer 106 may be capable of or configured to couple the one or more optically transparent sheets 102, 104 with one another. For example, the interlayer 106 may couple the first optically transparent sheet 102 and the second optically transparent sheet 104 with one another.

The one or more optically transparent sheets 102, 104 may be capable of or configured to provide or form an inner or outer face for the laminate 100. For example, the first optically transparent sheet 102 may be or form an outer or exterior face for the laminate 100, and the second optically transparent sheet 104 may be or form an inner or interior face for the laminate 100. The one or more optically transparent sheets 102, 104 may also be capable of or configured to provide, at least in part, a transparent, impact resistant mechanical and/or acoustic barrier for the laminate 100. The one or more outer transparent sheets 102, 104 may be or include, but are not limited to, a mineral glass, a rigid plastic, a polycarbonate, a polyacrylate, a cyclic polyolefin, a crystallized glass, soda glass, borosilicate glass, keraglass, thermally or chemically tempered glass, or any other mineral glass material, or the like, or any combination thereof.

The interlayer 106 may include one or more structural support layers 108, one or more polymeric layers 110, 112, or any combination thereof. For example, as illustrated in FIG. 1, the interlayer 106 may include a structural support layer 108, a first polymeric layer 110, and a second polymeric layer 112. As further illustrated in FIG. 1, the structural support layer 108 may be interposed between the first polymeric layer 110 and the second polymeric layer 112. It should be appreciated that other orientations or dispositions for the structural support layer 108 and the polymeric layers 110, 112 are contemplated.

The structural support layer 108 may be capable of or configured to, at least in part, provide the laminate 100 and/or the interlayer 106 thereof with sufficient or improved mechanical strength properties, load bearing properties, toughness, impact resistance, or any combination thereof. For example, the structural support layer 108 may be capable of or configured to, at least in part, provide the laminate 100 and/or the interlayer 106 thereof with sufficient or improved post glass-breakage mechanical strength and load bearing properties. The structural support layer 108 and/or materials thereof may be or include, but is not limited to, one or more of an ionomeric polymer, a structural polyvinyl acetal polymer, an ionomeric resin, a polycarbonate, a polymethyl methacrylate, a polyethylene terephthalate, a polyesterimide, a thermoplastic polyurethane (TPU), ethylene-vinyl acetate (EVA), a cross-linked ethylene-vinyl acetate, a resin thereof, or the like, or any combination thereof. Illustrative structural support layers and/or materials thereof may be or include, but are not limited to, one or more of SENTRYGLAS®, TROSIFOL®, and/or SENTRYGLAS PLUS®, each of which are commercially available from Kuraray America, Inc. of Houston, Texas, SAFLEX® and/or SAFLEX DG®, each of which are commercially available from Eastman Chemical Company of Kingsport, TN, or any combination thereof.

As used herein, the term or expression “ionomeric polymer,” “ionomer,” or the like, may refer to a polymer or copolymer including covalent bonds between the constituents of the long-chain molecules, and ionic bonds between the chains. As used herein, the term or expression “ionomeric resin,” “ionomer resin,” or the like, may refer to a copolymer including ethylene as the major component, but which contains both covalent and ionic bonds. For example, an ionomer resin may refer to a copolymer of ethylene and a vinyl monomer with an acid group, such as methacrylic acid. The ionomer resin may be a cross-linked polymer where that linkages are ionic as well as covalent bonds. Ionomeric polymers and resins may be transparent, electrically conductive, resilient, thermoplastic, or a combination thereof. Illustrative ionomeric polymers and ionomeric resins may be or include, but are not limited to, a copolymer of carboxylic acid or of acrylate ester with ethylene or any other reactive monomer, a copolymer disclosed for example in U.S. Pat. Nos. 5,763,062 and 4,663,228, the contents of which are hereby incorporated by reference, a commercial ionomer from one or more of the SENTRYGLAS® and SENTRYGLAS PLUS® families of products, a commercial ionomer from the NOVIFLEX® interlayer family, which is commercially available from AGP Plastics of Trumbauersville, PA, or the like, or any combination thereof.

The one or more polymeric layers 110, 112 may be capable of or configured to facilitate the adhesion of two or more components of the laminate 100 with one another. For example, the first polymeric layer 110 may be capable of or configured to facilitate the adhesion of the interlayer 106 with the first optically transparent sheet 102. Similarly, the second polymeric layer 112 may be capable of or configured to facilitate the adhesion of the interlayer 106 with the second optically transparent sheet 104. The one or more polymeric layers 110, 112 may be or include, but is not limited to, any suitable polymer capable of or configured to facilitate the adhesion of the two or more components of the laminate 100 with one another. Illustrative polymers for the one or more polymeric layers 110, 112 may be or include, but are not limited to, a thermoset, a thermoplastic, a thermoplastic urethane, an ethylene-vinyl acetate (EVA), an ionomer, a polyvinyl acetal with or without a plasticizer, or a combination thereof. In an exemplary implementation, one or more of the polymeric layers 110, 112 may include a polyvinyl acetal, such as polyvinyl butyral. The polyvinyl acetal (e.g., polyvinyl butyral) may include a plasticizer, such as triethylene glycol bis(2-ethylhexanoate). In at least one implementation, each of the polymeric layers 110, 112 may be prepared from different polymers. The different polymers of the polymeric layers 110, 112, however, may have a pummel adhesion to a rigid substrate (e.g., with the transparent sheet 102, 104) of at least 2, at least 3, at least 4, at least 5, or more. As used herein, the expression “pummel adhesion” may refer to the measure of how well laminated plies, such as glass or polymeric layers, adhere to one another after being subjected to mechanical impact. The pummel adhesion may be evaluated according to reference test ASTM C1908-21 or ASTM D6110 of the American Society for Testing and Materials (ASTM). It should be appreciated that other specific industry standards, such as ones utilized by automotive manufacturers, may also be utilized to determine pummel adhesion. It general, the method for determining or evaluating pummel adhesion may include preparing the sample and cooling the sample to a relatively lower temperature (e.g., about −18° C. to about −30° C.), pummeling with a blunt object at a standardized/predetermined intensity, number of hits, and force, and assessing the degree of adhesion (e.g., via visual inspection, etc.).

In at least one implementation, the one or more polymeric layers 110, 112 may include an adhesion promoter capable of or configured to facilitate or increase the adhesion of two or more components of the laminate 100 with one another. Illustrative adhesion promoters may be or include, but are not limited to, one or more of an organosilane, an organotitanate, a zirconate, a zircoaluminate, an alkyl phosphate ester, a suitable metal organic, an epoxy, or the like, or any combination thereof.

The one or more polymeric layers 110, 112 or a component thereof may be capable of or configured to, at least in part, provide luminescence or luminescence properties to the laminate 100 and/or the interlayer 106 thereof. As used herein, the term “luminescence” may refer to the emission of visible or invisible radiation unaccompanied by high temperature by any substance as a result of absorption of exciting energy in the form of light, photons, charged particles, or the like. Luminescence may include both fluorescence and phosphorescence. For example, the one or more polymeric layers 110, 112 may include one or more lumiphores capable of or configured to absorb at least a portion of near-infrared (NIR) and/or ultraviolet (UV) photons or light, and reemit the absorbed energy as visible or invisible radiation. In at least one implementation, at least one of the one or more polymeric layers 110, 112 includes a lumiphore. For example, the first polymeric layer 110 may include a lumiphore, the second polymeric layer 112 may include a lumiphore, or a combination of the first and second polymeric layers 110, 112 may include a lumiphore.

The one or more lumiphores may be configured to absorb the majority of NIR and/or UV photons and reemit the energy with a Stoke-shift of greater than or equal to about 200 nm. The lumiphores may include fluorescent compounds, phosphorescent compounds, or a combination thereof. The lumiphores may exhibit photoluminescent quantum yields of from about 50% to about 100%, about 70% to about 100%, or about 80% to about 100%. The lumiphores may have an absorption spectrum in the UV, visible, and/or NIR region of the electromagnetic spectrum. The lumiphores may have a maximum absorption at a wavelength of about 250 nm to about 800 nm, about 350 nm to about 550 nm, or about 400 nm to about 475 nm. The lumiphores may have an emission spectrum in the visible region with a maximum emission at a wavelength of from about 400 nm to about 800 nm, about 410 nm to about 750 nm, or about 430 nm to about 630 nm.

Illustrative lumiphores may be or include, but are not limited to, one or more of an inorganic colorant, an organic luminescent colorant, an organic dye, quantum dots, or the like, or any combination thereof. The lumiphores may also be or include a compound, complex, and/or ligand having one of the following structures: MX₂·L₂, AMX₂·L₂, M₆X₁₂·L₂, A₂M₆X₁₄, and A₂M₆X₁₄·L₂, where M may be tungsten (W) or molybdenum (Mo); X may be —Cl, —Br, or —I; L may be Cl, CH₃CN, a benzenethiol, ethanethiol, H₂O (a hydrate), HCl, or acetonitrile; and A may be a cation of K, Na, tetrabutylammonium (TBA), or any other suitable ammonium salt. The quantum dots may be or include a core/shell structure. Illustrative core/shell quantum dot structures may be or include, but are not limited to, one or more of CdSe/CdS, CdSe/ZnSe, CdSe/ZnS, CdSe/ZnTe, CdSe/CdTe, CdTe/CdSe, CdTe/CdS, CdTe/ZnSe, CdTe/ZnS, CdTe/ZnTe, CdS/ZnSe, CdS/ZnS, CdS/CdTe, CdS/CdSe, PbSe/PbS, PbS/PbSe, PbTe/PbS, PbS/PbTe, PbTe/PbSe, PbSe/PbTe, PbSe/CdSe, CdSe/PbTe, PbS/CdS, CdS/PbS, PbTe/CdTe, CdTe/PbTe, InAs/CdS, InSb/CdS, InP/CdS, InAs/CdSe, InSb/CdSe, InP/CdSe, InAs/ZnSe, InP/ZnSe, InSb/ZnSe, InAs/ZnS, InP/ZnS, InSb/ZnS, Ge/Si, Si/Ge, Sn/Si, Si/Sn, Ge/Sn, Sn/Ge, or the like, or any combination thereof.

It should be appreciated that in at least one implementation, one or more of the structural support layers 108 may provide one or more properties and/or functions of a polymeric layer 110, 112. Similarly, one or more polymeric layers may provide one or more properties and/or functions of a structural support layer.

In an exemplary implementation, illustrated in FIG. 1, the laminate 100 includes the first optically transparent sheet 102, the second optically transparent sheet 104, and the interlayer 106 interposed between the first and second optically transparent sheets 102, 104. The interlayer 106 being configured to couple or bond the first and second optically transparent sheets 102, 104 with one another. The interlayer includes the first polymeric layer 110, the second polymeric layer 112, and the structural support layer 108 interposed therebetween. The first polymeric layer 110 includes a thermoplastic polyurethane and one or more lumiphores. The one or more lumiphores of the first polymeric layer 108 are dispersed, mixed, or otherwise disposed in the thermoplastic polyurethane or the polymer matrix thereof. The second polymeric layer 112 includes a thermoplastic polyurethane. In one example, the second polymeric layer 112 includes one or more lumiphores. In another example, the second polymeric layer 112 does not include the lumiphores. The structural support layer 108 includes an ionomeric polymer. The laminate 100 and/or the interlayer 106 thereof has a haze of less than or equal to about 2%, less than or equal to about 1%, or less than or equal to about 0.7%. The laminate 100 and/or the interlayer 106 thereof has a light transmission of greater than or equal to about 30%, greater than or equal to about 50%, greater than or equal to about 70% or more. The laminate 100 and/or the interlayer 106 thereof has a quantum yield of greater than or equal to about 50%, greater than or equal to about 70%, greater than or equal to about 80%, greater than or equal to about 85%, greater than or equal to about 90%, or more, as measured according to ASTM E578 or ASTM E2719. The laminate 100 and/or the interlayer 106 thereof has an indentation resistance of greater than or equal to about 18 feet (about 5.5 meters), greater than or equal to about 20 feet, greater than or equal to about 24 feet, or more, as measured according to ASTM-D2394. The laminate 100 and/or the interlayer 106 thereof has a pummel adhesion of greater than or equal to about 4, greater than or equal to about 7, greater than or equal to about 8, greater than or equal to about 9, greater than or equal to about 10, greater than or equal to about 15, or more, as measured according to ASTM C1908-21. The laminate 100 and/or the interlayer 106 thereof has a shear storage modulus as measured at about 50° C. of greater than or equal to about 1 MPa, greater than or equal to about 2 MPa, greater than or equal to about 3 MPa, greater than or equal to about 5 MPa, or more, as measured according to ASTM D5279, D4065, and/or D4473.

In another exemplary implementation, illustrated in FIG. 1, the laminate 100 includes the first optically transparent sheet 102, the second optically transparent sheet 104, and the interlayer 106 interposed between the first and second optically transparent sheets 102, 104. The interlayer 106 being configured to couple or bond the first and second optically transparent sheets 102, 104 with one another. The interlayer includes the first polymeric layer 110, the second polymeric layer 112, and the structural support layer 108 interposed therebetween. The first polymeric layer 110 includes a thermoplastic polyurethane and one or more lumiphores. The one or more lumiphores of the first polymeric layer 108 are dispersed, mixed, or otherwise disposed in the thermoplastic polyurethane or the polymer matrix thereof. The second polymeric layer 112 includes a thermoplastic polyurethane. In one example, the second polymeric layer 112 includes one or more lumiphores. In another example, the second polymeric layer 112 does not include the lumiphores. The structural support layer 108 includes a polycarbonate, a polymethyl methacrylate, a polyethylene terephthalate, a polyesterimide, or a combination thereof, and being capable of or configured to provide the laminate or the interlayer thereof with increased penetration resistance. The laminate 100 and/or the interlayer 106 thereof has a haze of less than or equal to about 2%, less than or equal to about 1%, or less than or equal to about 0.7%, as determined according to reference test ASTM D1003. The laminate 100 and/or the interlayer 106 thereof has a light transmission of greater than or equal to about 30%, greater than or equal to about 50%, greater than or equal to about 70% or more, as determined according to reference test ASTM D1003. The laminate 100 and/or the interlayer 106 thereof has a quantum yield, as determined according to reference test ASTM E2719, of greater than or equal to about 50%, greater than or equal to about 70%, greater than or equal to about 80%, greater than or equal to about 85%, greater than or equal to about 90%, or more. The laminate 100 and/or the interlayer 106 thereof has an indentation resistance of greater than or equal to about 18 feet (about 5.5 meters), greater than or equal to about 20 feet, greater than or equal to about 24 feet, or more, as measured according to ASTM-D2394. The laminate 100 and/or the interlayer 106 thereof has a pummel adhesion of greater than or equal to about 4, greater than or equal to about 7, greater than or equal to about 8, greater than or equal to about 9, greater than or equal to about 10, greater than or equal to about 15, or more, as measured according to ASTM C1908-21. The laminate 100 and/or the interlayer 106 thereof has a shear storage modulus as measured at about 50° C. of greater than or equal to about 1 MPa, greater than or equal to about 2 MPa, greater than or equal to about 3 MPa, greater than or equal to about 5 MPa, or more, as determined according to ASTM D5279.

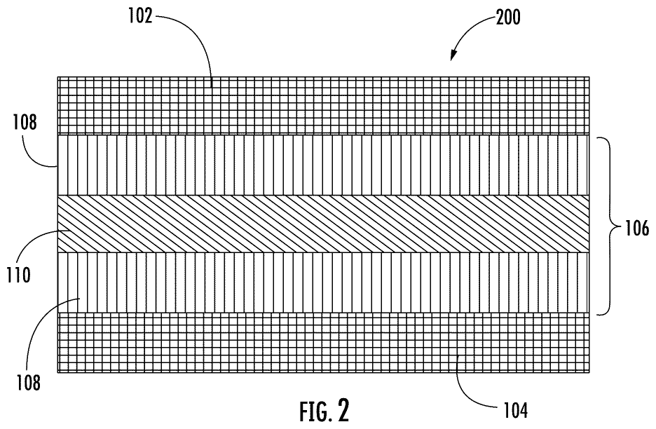

FIG. 2 is a schematic cross-sectional view of another exemplary laminate 200, according to one or more implementations. The laminate 200 may be similar in some respects to the laminate 100 described above and therefore may be best understood with reference to the description of FIG. 1, where like numerals designate like components and will not be described again in detail. As further described herein, the laminate 200 illustrated in FIG. 2 may be or provide a “reverse skin-core” configuration, where one or more polymeric layers including one or more lumiphores may be interposed between two or more structural support layers.

As illustrated in FIG. 2, the laminate 200 may include a first optically transparent sheet 102, a second optically transparent sheet 104, and an interlayer 106 interposed between the first and second optically transparent sheets 102, 104. As further illustrated in FIG. 2, the interlayer 106 may include a first structural support layer 108, a second structural support layer 108, and a polymeric layer 110 interposed between the first and second structural support layers 108.

In an exemplary implementation, the structural support layers 108 of the laminate 200 may be or include a thermoplastic polyurethane (TPU), an ethylene-vinyl acetate, a cross-linked ethylene-vinyl acetate, or a combination thereof. For example, the first and/or the second structural support layers 108 include a thermoplastic polyurethane (TPU). In another example, the first and/or the second structural support layers 108 include a cross-linked ethylene-vinyl acetate. In yet another example, the first and/or the second structural support layers 108 include a combination of the thermoplastic polyurethane and the cross-linked ethylene-vinyl acetate. It should be appreciated that the laminate 200 may include any number of structural support layers 108, where at least one of the polymeric layers 100 is interposed between the two or more structural support layers 108 in the “reverse skin-core” configuration. The polymeric layer 110 of the laminate 200 may include a thermoplastic polyurethane and one or more lumiphores. The laminate 200 and/or the interlayer 106 thereof has a haze of less than or equal to about 2%, less than or equal to about 1%, or less than or equal to about 0.7%. The laminate 200 and/or the interlayer 106 thereof has a light transmission of greater than or equal to about 30%, greater than or equal to about 50%, greater than or equal to about 70% or more. The laminate 200 and/or the interlayer 106 thereof has a quantum yield of greater than or equal to about 50%, greater than or equal to about 70%, greater than or equal to about 80%, greater than or equal to about 85%, greater than or equal to about 90%, or more. The laminate 200 and/or the interlayer 106 thereof has an indentation resistance of greater than or equal to about 18 feet (about 5.5 meters), greater than or equal to about 20 feet, greater than or equal to about 24 feet, or more, as measured according to ASTM-D2394. The laminate 200 and/or the interlayer 106 thereof has a pummel adhesion of greater than or equal to about 4, greater than or equal to about 7, greater than or equal to about 8, greater than or equal to about 9,greater than or equal to about 10, greater than or equal to about 15, or more, as measured according to ASTM C1908-21. The laminate 200 and/or the interlayer 106 thereof has a shear storage modulus as measured at about 50° C. of greater than or equal to about 1 MPa, greater than or equal to about 2 MPa, greater than or equal to about 3 MPa, greater than or equal to about 5 MPa, or more.

The laminate 100, 200, the respective interlayer 106, the structural support layers 108, and/or the polymeric layers 110, 112 thereof may be free or substantially free of plasticizers. For example, at least one of the structural support layers 108, at least one of the polymeric layers 110, 112, or a combination thereof, may be free or substantially free of plasticizers. Similarly, at least one of the structural support layers 108, at least one of the polymeric layers 110, 112, or a combination thereof, may include a plasticizer. In one example, at least one of the polymeric layers 110, 112 may include a plasticizer and the remaining polymeric layer 110, 112 may exclude the plasticizer. It should be appreciated that plasticizers may react with one or more portions or layers of the interlayer 106, thereby resulting in the degradation of the optical clarity, such as light transmission and haze, of the laminate 100, 200 and/or the respective interlayer 106 thereof. Accordingly, the laminates 100, 200 and/or the respective interlayer 106 discussed herein that are free or substantially free of the plasticizers are free from mechanical and/or optical degradation associated with the inclusion of the plasticizers. It should be appreciated that the laminate 100, 200 and/or the respective interlayer 106 discussed herein may exclude the plasticizers while maintaining or improving one or more properties (e.g., impact resistance, load bearing, luminescence, etc.) of the laminate 100, 200 and/or the respective interlayer 106 thereof as compared to conventional laminates including one or more plasticizers.

As used herein, the term “plasticizer” may refer to a substance (e.g., a solvent), added to a material (e.g., resin, plastic, polymer, etc.) to produce, increase, or promote plasticity (e.g., softening and flexibility), reduce brittleness, decrease viscosity, degrease friction, or the like, or any combination thereof. Conventional plasticizers are generally known in the art. Illustrative plasticizers may be or include, but are not limited to, one or more organic solvents. The organic solvent may be selected from a material that provides sufficient ionic conductivity to provide a suitable switching speed for the laminates 100, 200. The organic solvent may be or include, but is not limited to, an organic carbonate solvent, a lactone solvent, or any combination thereof. Illustrative lactone solvents may be or include, but are not limited to, propiolactones, butyrolactones, crotonolactones, valerolactones, or the like, or any mixture or combination thereof. Illustrative organic carbonate solvents may be or include, but are not limited to, diethyl carbonate, propylene carbonate, ethylene carbonate, gammabutryrolactone, dimethyl carbonate, methyl ethyl carbonate, glycerin carbonate, butylene carbonate, alkylene carbonate, or the like, or any combination thereof. In an exemplary implementation, the organic carbonate solvent includes one or more of diethyl carbonate, propylene carbonate, ethylene carbonate, or any combination thereof. Illustrative plasticizers may also be or include, but are not limited to, one or more of a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyethers, including but not limited to, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), and polyethylene glycol bis(2-ethylhexanoate) (PEG-EH), organophosphates, including but not limited to, tricresyl phosphate (TCP) and tributyl phosphate (TBP), alkyl citrates, glycerol, acetylated monoglycerides, or the like, or any combination or mixture thereof. In at least one implementation, when a plasticizer is utilized, one of the foregoing plasticizers may be utilized in combination with an organic carbonate solvent. It should be appreciated that the laminate 100, 200, the respective interlayer 106, the structural support layers 108, and/or the polymeric layers 110, 112 thereof may each include one or more of the foregoing plasticizers, exclude (i.e., free or substantially free) one or more of the foregoing plasticizers, or be free or substantially free of all of the foregoing plasticizers.

The laminate 100, 200 and/or the respective interlayers 106 discussed herein may have a haze, as measured according to reference test ASTM-D1003 of the American Society for Testing and Materials (ASTM), of less than or equal to about 5%. For example, the laminate 100, 200 and/or the respective interlayers 106 described herein may have a haze, as measured according to ASTM-D1003 of less than or equal to about 5%, less than or equal to about 4%, less than or equal to about 3%, less than or equal to about 2%, less than or equal to about 1%, or less than or equal to about 0.7%.

The laminate 100, 200 and/or the respective interlayers 106 discussed herein may have a light transmission of greater than or equal to about 30%, greater than or equal to about 50%, greater than or equal to about 70% or more.

The laminate 100, 200 and/or the respective interlayers 106 discussed herein may have a quantum yield of greater than or equal to about 50%, greater than or equal to about 70%, greater than or equal to about 80%, greater than or equal to about 85%, greater than or equal to about 90%, or more.

The laminate 100, 200 and/or the respective interlayers 106 discussed herein may have an impact or indentation resistance of greater than or equal to about 18 feet (about 5.5 meters), greater than or equal to about 20 feet, greater than or equal to about 24 feet, or more, as measured according to ASTM-D2394.

The laminate 100, 200 and/or the respective interlayers 106 discussed herein may have a pummel adhesion of greater than or equal to about 4, greater than or equal to about 7, greater than or equal to about 8, greater than or equal to about 9, greater than or equal to about 10, greater than or equal to about 15, or more, as measured according to ASTM C1908-21.

The laminate 100, 200 and/or the respective interlayers 106 discussed herein may have a shear storage modulus as measured at about 50° C. of greater than or equal to about 1 MPa, greater than or equal to about 2 MPa, greater than or equal to about 3 MPa, greater than or equal to about 5 MPa, or more. The shear storage modulus may be measured by or via a dynamic mechanical thermal analysis (DMTA) at a measurement frequency of about 1 Hz and a sweep rate of about 3° C./min.

In at least one implementation, one or more properties, dimensions, compositions, components of the interlayer 106 may be selected or modified to provide or achieve the foregoing haze, light transmission, quantum yield, indentation resistance, pummel adhesion, shear storage modulus, or any combination thereof. For example, referring to the laminate 100 of FIG. 1, the thickness and/or composition of the first polymeric layer 110 and/or the second polymeric layer 112 may be selected or modified to achieve the foregoing haze, light transmission, quantum yield, indentation resistance, pummel adhesion, shear storage modulus, or any combination thereof. More particularly, the thickness and composition of the first and second polymeric layers 110, 112 of the laminate 100 may be selected or modified (i.e., increased or decreased) to provide a haze of about 2% or less, about 1% or less, or about 0.7% or less; a light transmission of about 30% or more, about 50% or more, or about 70% or more; a quantum yield of about 50% or more; and/or a shear storage modulus of about 1 MPa or more, about 5 MPa or more, or about 10 MPa or more. In another example, the composition of the structural support layer 108 of the laminate 100 may be selected to provide an impact or indentation resistance of greater than or equal to about 18 feet (about 5.5 meters), greater than or equal to about 20 feet, greater than or equal to about 24 feet, or more, as measured according to ASTM-D2394; and/or a shear storage modulus as measured at about 50° C. of greater than or equal to about 1 MPa, greater than or equal to about 2 MPa, greater than or equal to about 3 MPa, greater than or equal to about 5 MPa, or more.

The one or more structural support layers 108 may have a thickness of from about 30 μm to about 2,000 μm. For example, the one or more structural support layers 108 may have a thickness of from about 30 μm, about 50 μm, about 100 μm, about 200 μm, about 300 μm, about 350 μm, about 500 μm, about 700 μm, or about 800 μm to about 900 μm, about 1,000 μm, about 1,100 μm, about 1,170 μm, about 1,300 μm, about 1,500 μm, about 1,800 μm, or about 2,000 μm. In another example, the one or more structural support layers 108 may have a thickness of from about 50 μm to about 2,000 μm, about 300 μm to about 1200 μm, or about 350 μm to about 1,170 μm. In an exemplary implementation, the structural support layer 108 of the laminate 100 of FIG. 1 may have a thickness of from about 50 μm to about 2,000 μm, about 300 μm to about 1200 μm, or about 350 μm to about 1,170 μm. It should be appreciated that the structural support layers 108 of the laminate 200 illustrated in FIG. 2 may be the same or different. For example, one of the structural support layers 108 may have a thickness relatively greater than a thickness of the other structural support layer 108. In an exemplary implementation, the respective thickness of any one of the structural support layers 108 of the laminate 200 of FIG. 2 may be from about 30 μm to about 500 μm, about 40 μm to about 450 μm, about 50 μm to about 410 μm, about 80 μm to about 350 μm, or about 100 μm to about 200 μm.

The one or more polymeric layers 110, 112 may have a thickness of from about 30 μm to about 2,000 μm. For example, the one or more polymeric layers 110, 112 may have a thickness of from about 30 μm, about 50 μm, about 70 μm, about 100 μm, about 150 μm, about 250 μm, about 350 μm about 500 μm, about 600 μm, or about 700 μm to about 800 μm, about 900 μm, about 1,000 μm, about 1,200 μm, about 1,400 μm, about 1,600 μm, about 1,800 μm, or about 2,000 μm. The thickness of the polymeric layers 110, 112 of the laminate 100 of FIG. 1 may be the same or different. In an exemplary implementation, the respective thickness of each of the polymeric layers 110, 112 of the laminate 100 may be from about 30 μm to about 1,000 μm, about 50 μm to about 800 μm, about 70 μm to about 700 μm, about 100 μm to about 500 μm, or about 150 μm to about 410 μm. The polymeric layer 110 of the laminate 200 of FIG. 2 may be from about 30 μm, about 50 μm, about 100 μm, about 200 μm, about 250 μm, about 300 μm, about 355 μm, about 400 μm, about 600 μm, or about 700 μm to about 800 μm, about 900 μm, about 1,000 μm, about 1,100 μm, about 1,170 μm, or about 1,200 μm. In an exemplary implementation, the polymeric layer 110 of the laminate 200 may have a thickness of from about 50 μm to about 1,170 μm, or about 355 μm to about 1,170 μm.

The interlayer 106 may have a thickness of from about 300 μm to about 2,500 μm. For example, the respective interlayer 106 of any one of the laminates 100, 200 may have a thickness of from about 300 μm, about 350 μm, about 500 μm, about 600 μm or about 650 μm to about 700 μm, about 750 μm, about 800 μm, about 900 μm, about 1,200 μm, about 1,500 μm, or about 2,000 μm. In an exemplary implementation, the respective interlayer 106 of any one of the laminates 100, 200 may have a thickness of from about 350 μm to about 1,900 μm, about 500 μm to about 1,000 μm, or about 600 μm to about 790 μm. It should be appreciated that respective thickness of the interlayer 106, and/or the structural support layer(s) 108 and/or the polymeric layer(s) 110, 112 thereof may be adjusted or modified to achieve the haze, light transmission, quantum yield, indentation resistance, pummel adhesion, shear storage modulus, or any combination thereof, described herein.

In at least one implementation, the laminates 100, 200 and/or the interlayers 106 thereof may be capable of providing or configured to provide one or more functions and/or properties of a photovoltaic cell, a photovoltaic assembly, an electrochromic cell, an electrochromic assembly, or any combination thereof. For example, the laminates 100, 200, the interlayer 106, and/or one or more components thereof may be selected or modified to provide one or more functions and/or properties of a photovoltaic cell, a photovoltaic assembly, an electrochromic cell, an electrochromic assembly, or any combination thereof, and maintain a haze of less than or equal to about 2%, less than or equal to about 1%, or less than or equal to about 0.7%; a light transmission of greater than or equal to about 30%, greater than or equal to about 50%, greater than or equal to about 70% or more; a quantum yield of greater than or equal to about 50%, greater than or equal to about 70%, greater than or equal to about 80%, greater than or equal to about 85%, greater than or equal to about 90%, or more; an impact or indentation resistance of greater than or equal to about 18 feet (about 5.5 meters), greater than or equal to about 20 feet, greater than or equal to about 24 feet, or more, as measured according to ASTM D2394; a pummel adhesion of greater than or equal to about 4, greater than or equal to about 7, greater than or equal to about 8, greater than or equal to about 9, greater than or equal to about 10, greater than or equal to about 15, or more, as measured according to ASTM C1908-21; and/or a shear storage modulus as measured at about 50° C. of greater than or equal to about 1 MPa, greater than or equal to about 2 MPa, greater than or equal to about 3 MPa, greater than or equal to about 5 MPa, or more.

In at least one implementation, the laminates 100, 200 and/or the interlayer 106 discussed herein may be prepared as a photovoltaic assembly. For example, one or more of the polymeric layers 110, 112 may include one or more colloidal semiconductor nanocrystals or quantum dots dispersed therein. In operation, light (e.g., natural light or sunlight) may excite electrons of the quantum dots, and the quantum dots may direct or guide the light to respective edges or sides of the polymeric layers 110, 112. Photovoltaic cells (not shown) may be disposed in intimate or direct contact with the sides or edges of one or more of the polymeric layers 110, 112 to convert the light to electrical energy. It should be appreciated that other luminescent solar concentrators may be utilized in lieu or in conjunction with the quantum dots.

In at least one implementation, the laminates 100, 200 and/or the interlayer 106 discussed herein may be prepared as an electrochromic assembly. For example, the interlayer 106 of one or more of the laminates 100, 200 may be configured as an ion conducting interlayer. For example, one or more of the polymeric layers 110, 112 of the interlayer 106 may include one or more salts or any other appropriate ion conducting compounds or materials to facilitate the preparation of the ion conducting interlayer. The one or more salts may be or include, but are not limited to, an alkali or alkaline earth metal salt, such as a lithium salt or salts with cations having the elements of Na, K, Cs, Mg and Ag. Illustrative lithium salts may be or include, but are not limited to, one or more of LiCl, LiF, LiI, LiNO₃, LiClO₄, LiBF₄, LiPF₆, LiAsF₆, lithium triflate, lithium imide, LiTFSI, LiTDI, or the like, or any combination thereof. The laminates 100, 200 as an electrochromic assembly may further be configured to include a first electrode or first electrode layer (not shown) between the first optically transparent sheet 102 and the ion conducting interlayer 106, and a second electrode or second electrode layer (not shown) between the second optically transparent sheet 104 and the ion conducting interlayer 106. Each of the first and second electrodes or electrode layers may be fabricated or prepared from a transparent conductive film or a transparent conductive coating. Illustrative transparent conductive films and/or coatings may be or include, but are not limited to, indium tin oxide (ITO), other conventional transparent conductive oxides, a conductive polymer, metal meshes, carbon nanoparticles (e.g., nanotubes), graphene, nanowires, metal films, or the like, or any combination thereof.

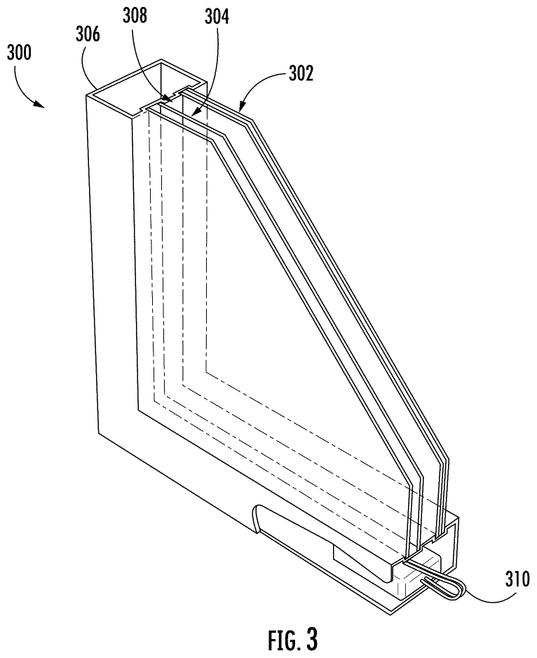

In at least one implementation, the laminates 100, 200 and/or the interlayer 106 discussed herein may be utilized in the preparation or fabrication of a multilayer laminate or multilayer laminate assembly, such as an insulated glass unit. FIG. 3 illustrates a partial, cross-sectional view of a multilayer laminate assembly 300, according to one or more implementations. The multilayer laminate assembly 300 may include one or more electrochromic assemblies 302, one or more photovoltaic assemblies 304, additional laminates (not shown), or any combination thereof. For example, as illustrated in FIG. 4, the multilayer laminate assembly 300 includes an electrochromic assembly 302 and a photovoltaic assembly 304 disposed adjacent and proximal to one another. It should be appreciated that the laminates 100, 200 and/or the interlayer 106 discussed herein may be modified or utilized in the preparation of the electrochromic assembly 302 and/or the photovoltaic assembly 304 of the multilayer laminate assembly 300, as discussed herein.

In at least one implementation, the electrochromic assembly 302 and the photovoltaic assembly 304 may be coupled with one another via a frame 306 of the multilayer laminate assembly 300. As further illustrated in FIG. 3, the electrochromic assembly 303 and the photovoltaic assembly 304 may define a gap or space 308 therebetween. The gap or space 308 may be a vacuum or may include a gas, including, but not limited to, air, nitrogen, argon, krypton, or any other suitable gas, or any combination thereof.

The electrochromic assembly 302 and the photovoltaic assembly 304 may be operably coupled with one another. For example, the electrochromic assembly 302 and the photovoltaic assembly 304 may be electrically coupled with one another via one or more electrical conduits or conductors 310. Illustrative electrical conduits or conductors 310 may be or include, but are not limited to, one or more wires, busbars, conductive traces, or any other suitable electrical conduits known in the art. In operation, with continued reference to FIG. 3, the photovoltaic assembly 304 may power or provide power to the electrochromic assembly 302 via the electrical conduit 310. In an alternative operation, an external source (not shown) may provide the power to the electrochromic assembly 302.

The following numbered paragraphs are directed to one or more exemplary variations of the subject matter of the application:
1. A laminate, comprising: a first optically transparent sheet; a second optically transparent sheet; and an interlayer interposed between the first optically transparent sheet and the second optically transparent sheet and coupling the first and second optically transparent sheets with one another, the interlayer comprising: one or more structural support layers; and one or more polymeric layers, wherein a first polymeric layer of the one or more polymeric layers comprising a luminophore, and wherein the interlayer is substantially free of plasticizers.
2. The laminate of paragraph 1, wherein the first polymeric layer comprises a thermoplastic polyurethane, and wherein the luminophore is disposed in the thermoplastic urethane.
3. The laminate of paragraph 1 or paragraph 2, wherein a second polymeric layer of the one or more polymeric layers comprises a thermoplastic polyurethane.
4. The laminate of paragraph 3, wherein the second polymeric layer comprises a luminophore.
5. The laminate of paragraph 3, wherein the second polymeric layer does not comprise a luminophore.
6. The laminate of any one of paragraphs 3 to 5, wherein the one or more structural support layers are interposed between the first polymeric layer and the second polymeric layer.
7. The laminate of any one of paragraphs 1 to 6, wherein the one or more structural support layers comprise an ionomeric polymer.
8. The laminate of any one of paragraphs 1 to 6, wherein the one or more structural support layers comprise a polycarbonate, a polymethyl methacrylate, a polyethylene terephthalate, a polyesterimide, or a combination thereof.
9. The laminate of paragraph 1 or 2, the one or more structural support layers comprise a first structural support layer and a second structural support layer.
10. The laminate of paragraph 9, wherein at least one of the first structural support layer and the second structural support layer comprises a thermoplastic polyurethane, a cross-linked ethylene-vinyl acetate, or a combination thereof.
11. The laminate of paragraph 9 or 10, wherein each of the first structural support layer and the second structural support layer comprises the thermoplastic polyurethane.
12. The laminate of paragraph 9 or 10, wherein each of the first structural support layer and the second structural support layer comprises the cross-linked ethylene-vinyl acetate.
13. The laminate of any one of paragraphs 9 to 12, wherein the first polymeric layer is interposed between the first structural support layer and the second structural support layer.
14. The laminate of any one of the foregoing paragraphs, wherein at least the first polymeric layer of the one or more polymeric layers comprises an adhesion promoter.
15. The laminate of any one of the foregoing paragraphs, wherein the luminophore comprises one or more of an organic phosphorescent molecule, a quantum dot, an organic dye, a fluorophore, or a combination thereof.
16. The laminate of paragraph 15, wherein the luminophore comprises the organic phosphorescent molecule.
17. The laminate of paragraph 15 or 16, wherein the luminophore comprises a quantum dot.
18. The laminate of paragraph 17, wherein the quantum dot comprises a core/shell structure selected from one or more of CdSe/CdS, CdSe/ZnSe, CdSe/ZnS, CdSe/ZnTe, CdSe/CdTe, CdTe/CdSe, CdTe/CdS, CdTe/ZnSe, CdTe/ZnS, CdTe/ZnTe, CdS/ZnSe, CdS/ZnS, CdS/CdTe, CdS/CdSe, PbSe/PbS, PbS/PbSe, PbTe/PbS, PbS/PbTe, PbTe/PbSe, PbSe/PbTe, PbSe/CdSe, CdSe/PbTe, PbS/CdS, CdS/PbS, PbTe/CdTe, CdTe/PbTe, InAs/CdS, InSb/CdS, InP/CdS, InAs/CdSe, InSb/CdSe, InP/CdSe, InAs/ZnSe, InP/ZnSe, InSb/ZnSe, InAs/ZnS, InP/ZnS, InSb/ZnS, Ge/Si, Si/Ge, Sn/Si, Si/Sn, Ge/Sn, Sn/Ge, or a combination thereof.
19. The laminate of any one of the foregoing paragraphs, further comprising one or more adhesive promoters disposed in the first polymeric layer, the second polymeric layer, or a combination thereof.
20. The laminate of any one of the foregoing paragraphs, wherein the laminate comprises a haze of less than or equal to about 2%.
21. The laminate of any one of the foregoing paragraphs, wherein the laminate comprises a light transmission of greater than or equal to about 30%.
22. The laminate of any one of the foregoing paragraphs, wherein the laminate comprises a quantum yield of greater than or equal to about 50%.
23. The laminate of any one of the foregoing paragraphs, wherein the laminate comprises an indentation resistance of greater than or equal to about 18 feet, or greater than or equal to about 5.5 meters, as measured according to ASTM-D2394.
24. The laminate of any one of the foregoing paragraphs, wherein the laminate comprises a pummel adhesion of greater than or equal to about 4, as measured according to ASTM C1908-21.
25. The laminate of any one of the foregoing paragraphs, wherein the laminate comprises a shear storage modulus of greater than or equal to about 1 MPa, as measured at about 50° C.
26. A laminate, comprising: a first optically transparent sheet; a second optically transparent sheet; and an interlayer interposed between the first optically transparent sheet and the second optically transparent sheet, wherein the interlayer is substantially free of plasticizers, and wherein the interlayer comprises: a first polymeric layer comprising a luminophore and a thermoplastic polyurethane; a second polymeric layer comprising a thermoplastic urethane; and a structural support layer interposed between the first polymeric layer and the second polymeric layer.
27. The laminate of paragraph 27, wherein the second polymeric layer comprises a luminophore.
28. The laminate of paragraph 27, wherein the second polymeric layer does not comprise a luminophore.
29. The laminate of any one of paragraphs 27 to 29, wherein the one or more structural support layers comprise an ionomeric polymer.
30. The laminate of any one of paragraphs 27 to 29, wherein the one or more structural support layers comprise a polycarbonate, a polymethyl methacrylate, a polyethylene terephthalate, a polyesterimide, or a combination thereof.
31. A laminate, comprising: a first optically transparent sheet; a second optically transparent sheet; and an interlayer interposed between the first optically transparent sheet and the second optically transparent sheet, wherein the interlayer is substantially free of plasticizers, and wherein the interlayer comprises: a first structural support layer comprising a thermoplastic polyurethane or a cross-linked ethylene-vinyl acetate; a second structural support layer comprising a thermoplastic polyurethane or a cross-linked ethylene-vinyl acetate; and a polymeric layer interposed between the first structural support layer and the second structural support layer, the polymer layer comprising a luminophore.
32. The laminate of paragraph 31, wherein at least one of the first structural support layer and the second structural support layer comprises a thermoplastic polyurethane, a cross-linked ethylene-vinyl acetate, or a combination thereof.
33. The laminate of paragraph 32, wherein each of the first structural support layer and the second structural support layer comprises the thermoplastic polyurethane.
34. The laminate of paragraph 32, wherein each of the first structural support layer and the second structural support layer comprises the cross-linked ethylene-vinyl acetate.
35. The laminate of any one of paragraphs 1 to 34, wherein the plasticizer is present in the interlayer in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the laminate.
36. A window, comprising the laminate of any one of the foregoing paragraphs.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A laminate, comprising:
a first optically transparent sheet;
a second optically transparent sheet; and
an interlayer interposed between the first optically transparent sheet and the second optically transparent sheet and coupling the first and second optically transparent sheets with one another, the interlayer comprising:
one or more structural support layers; and
one or more polymeric layers, wherein a first polymeric layer of the one or more polymeric layers comprising a luminophore, and wherein the interlayer is substantially free of plasticizers.

2. The laminate of claim 1, wherein the first polymeric layer comprises a thermoplastic polyurethane, and wherein the luminophore is disposed in the thermoplastic urethane.

3. The laminate of claim 2, wherein the one or more polymeric layers further comprises a second polymeric layer, wherein the second polymeric layer of the one or more polymeric layers comprises a thermoplastic polyurethane.

4. The laminate of claim 3, wherein the second polymeric layer comprises a luminophore.

5. The laminate of claim 3, wherein the second polymeric layer does not comprise a luminophore.

6. The laminate of claim 3, wherein the one or more structural support layers are interposed between the first polymeric layer and the second polymeric layer.

7. The laminate of claim 1, wherein the one or more structural support layers comprise an ionomeric polymer.

8. The laminate of claim 1, wherein the one or more structural support layers comprise a polycarbonate, a polymethyl methacrylate, a polyethylene terephthalate, a polyesterimide, or a combination thereof.

9. The laminate of claim 1, the one or more structural support layers comprise a first structural support layer and a second structural support layer.

10. The laminate of claim 9, wherein at least one of the first structural support layer and the second structural support layer comprises a thermoplastic polyurethane, a cross-linked ethylene-vinyl acetate, or a combination thereof.

11. The laminate of claim 9, wherein the first polymeric layer is interposed between the first structural support layer and the second structural support layer.

12. The laminate of claim 1, wherein at least the first polymeric layer of the one or more polymeric layers comprises an adhesion promoter, and wherein the luminophore comprises one or more of an organic phosphorescent molecule, a quantum dot, an organic dye, a fluorophore, or a combination thereof.

13. The laminate of claim 1, further comprising one or more adhesive promoters disposed in the first polymeric layer, the second polymeric layer, or a combination thereof.

14. The laminate of claim 1, wherein the laminate comprises one or more of:
a haze of less than or equal to about 2%;
a light transmission of greater than or equal to about 30%;
a quantum yield of greater than or equal to about 50%;
an indentation resistance of greater than or equal to about 18 feet, as measured according to ASTM-D2394;
a pummel adhesion of greater than or equal to about 4, as measured according to ASTM C1908-21; and
a shear storage modulus of greater than or equal to about 1 MPa, as measured at about 50° C.

15. A laminate, comprising:
a first optically transparent sheet;
a second optically transparent sheet; and
an interlayer interposed between the first optically transparent sheet and the second optically transparent sheet, wherein the interlayer is substantially free of plasticizers, and wherein the interlayer comprises:
a first polymeric layer comprising a luminophore and a thermoplastic polyurethane;
a second polymeric layer comprising a thermoplastic urethane; and
one or more structural support layers interposed between the first polymeric layer and the second polymeric layer.

16. The laminate of claim 15, wherein the second polymeric layer comprises a luminophore.

17. The laminate of claim 15, wherein the second polymeric layer does not comprise a luminophore.

18. The laminate of claim 15, wherein the one or more structural support layers comprise a polycarbonate, a polymethyl methacrylate, a polyethylene terephthalate, a polyesterimide, or a combination thereof.

19. A laminate, comprising:
a first optically transparent sheet;
a second optically transparent sheet; and
an interlayer interposed between the first optically transparent sheet and the second optically transparent sheet, wherein the interlayer is substantially free of plasticizers, and wherein the interlayer comprises:
a first structural support layer comprising a thermoplastic polyurethane or a cross-linked ethylene-vinyl acetate;
a second structural support layer comprising a thermoplastic polyurethane or a cross-linked ethylene-vinyl acetate; and
a polymeric layer interposed between the first structural support layer and the second structural support layer, the polymer layer comprising a luminophore.

20. The laminate of claim 19, wherein each of the first structural support layer and the second structural support layer comprises the thermoplastic polyurethane.

21. The laminate of claim 19, wherein each of the first structural support layer and the second structural support layer comprises the cross-linked ethylene-vinyl acetate.

22. A window, comprising the laminate of claim 19.
